(19) United States
(12) Patent Application Publication
(10) Pub. No.: US 2005/0178678 A1
(43) Pub. Date: Aug. 18, 2005

(54) Packaging tape with integrated tear cord and apparatus for dispensing same

(76) Inventors: Ivan Pawlenko, Holland, PA (US); Larry Samson, Langhorne, PA (US)

Correspondence Address: DUANE MORRIS, LLP;IP DEPARTMENT, ONE LIBERTY PLACE, PHILADELPHIA, PA, 19103-7396, US

(21) Appl. No.: 10/777,618

(22) Filed: Feb. 12, 2004

(51) Int. Cl. B32B 7/12; B65D 69/00

(52) U.S. Cl. 206/225; 428/343

(57) ABSTRACT

A packing tape containing an integrated slicing means and an apparatus for dispensing the packing tape is disclosed. In one aspect of the invention, the dispensing apparatus comprises a cutting blade operable to cut the packing tape perpendicular to its longitudinal axis, a roller operable to deliver the packing tape to the cutting blade. In another aspect the apparatus includes a notch creating means that forms a tab and/or notch in the packing tape. In still another aspect of the invention, the apparatus includes at least one protrusion creating means between the cutting blade and the roller operable to create a plurality of protrusions a fixed distance from an edge created by the cutting blade.

### FIELD OF INVENTION

The present invention is related to packaging tape and more specifically to an easy-open package sealing tape containing an integrated tearing cord and an apparatus for dispensing the cord embedded packing tape.

### BACKGROUND OF THE RELATED ART

Adhesive-backed packaging tapes are ubiquitous items of commerce that are used by commercial industries and consumers for sealing packages or packing materials prior to their shipment. Tape has generally replaced strings or cords in securing packing materials as they are easier to apply and do not create any surface that may become ensnared in package sorting equipment.

However, when the sealed packages are to be opened, the adhesiveness of the tape prevents the tape from easily being removed. Further, the tape tears when an attempt to pull it occurs because the tape is generally very thin. Thus, a cutting tool, e.g., knife, box-cutter, scissors, etc., is typically used to slice through the tape to open the package. In one case, the use of a cutting tool requires that the tool be readily available, otherwise time is lost while the user searches for the cutting tool. In a second case, the use of a cutting tool presents a danger to its user or the product contained within the package as the sharp edge or blade may cut the user or scratch or damage the product. In these cases, significant loss in productivity may occur as the user searches for a cutting tool, or when using the tool is injured or damages the product.

Thus, there is a need in the industry for a sealing tape that can be used to properly seal packages while not requiring cutting tools to open the sealed packages.

### SUMMARY OF THE INVENTION

A packing tape containing an integrated slicing means and an apparatus for dispensing the packing tape is disclosed. In one aspect of the invention, the dispensing apparatus comprises a cutting blade operable to cut the packing tape perpendicular to its longitudinal axis, a roller operable to deliver the packing tape to the cutting blade. In another aspect the apparatus includes a notch creating means that forms a tab and/or notch in the packing tape. In still another aspect of the invention, the apparatus includes at least one protrusion creating means positioned perpendicular to the longitudinal axis between the cutting blade and the roller operable to create a plurality of protrusions a fixed distance from an edge created by the cutting blade.

### BRIEF DESCRIPTION OF THE FIGURES

FIG. 1a illustrates perspective view of a sealing tape in accordance with a first exemplary embodiment of the present invention;

FIG. 1b illustrates a cross-sectional view of a sealing tape shown in FIG. 1a;

FIG. 2a illustrates a prospective view of a sealing tape in accordance with a second exemplary embodiment of the present invention;

FIG. 2b illustrates a prospective view of a sealing tape in accordance with a second aspect of the exemplary embodiment shown in FIG. 2a;

FIG. 2c illustrates a prospective view of a sealing tape in accordance with a third aspect of the exemplary embodiment shown in FIG. 2a;

FIG. 3 illustrates a prospective view of an exemplary embodiment of an apparatus for creating and dispensing the sealing tape in accordance with the principles of the invention;

FIG. 4 illustrates a top view of an exemplary embodiment of a cutting edge used for creating a sealing tape in accordance with the principles of the invention;

FIG. 5 illustrates a side view of an exemplary embodiment of an apparatus for creating and dispensing a sealing tape in accordance with the principles of the invention; and

FIG. 6 illustrates a partial top view of the apparatus shown in FIG. 5.

It is to be understood that these drawings are solely for purposes of illustrating the concepts of the invention and are not intended as a definition of the limits of the invention. The embodiments shown in figures herein and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION

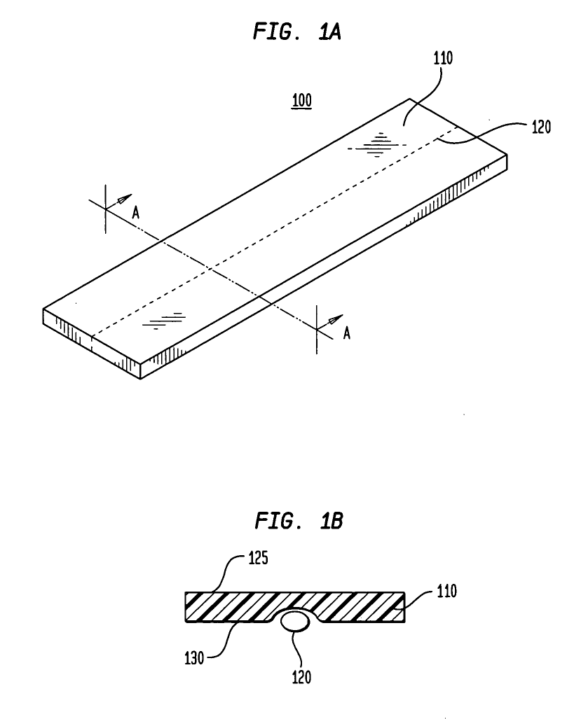

FIG. 1a illustrates a perspective view 100 of an exemplary embodiment of the sealing tape 110 in accordance with the principles of the invention. In this embodiment, a slicing means 120 is integrally attached to the material comprising packaging tape 110. In this illustrative embodiment, slicing means 120 is placed substantially in the center of tape with regard to its longitudinal axis. The slicing means 120 may for example be selected as a cord, string, rope, twine, or filament that may be manufactured from materials such as fabric or a metal.

Slicing means 120, thus, when pulled, separates packaging tape 110 about the cord enabling the sealed package to be opened without the use of an extrinsic cutting tool. In one aspect, slicing means 120 is selected based on the composition of the tape such that the slicing means 120 contains sufficient tensile strength to cut or slice through the material of tape 110 without itself breaking. For example, slicing means 120 may be a fabric, a nylon, an aluminum etc. filament.

FIG. 1b illustrates a cross-sectional view through section A-A, which is substantially perpendicular to a longitudinal axis of the packing tape 110 shown in FIG. 1a. As shown packing tape 110 is shown to include top surface 125 and a bottom surface 130. Conventionally, the bottom surface may include an adhesive that allows tape 110 to remain in contact with the package surface. As would be recognized by those skilled in the art, the adhesive on surface 130 may be a dry adhesive that is activated upon contact or a wet adhesive that requires moisture to be activated.

Also shown is integrated slicing means 120 substantially centered with regard to the longitudinal edges of tape 110. Although slicing means 120 is shown external to material 1120, one skilled in the art would recognize that slicing means 120 may be internally positioned between top surface 125 and bottom surface 130.

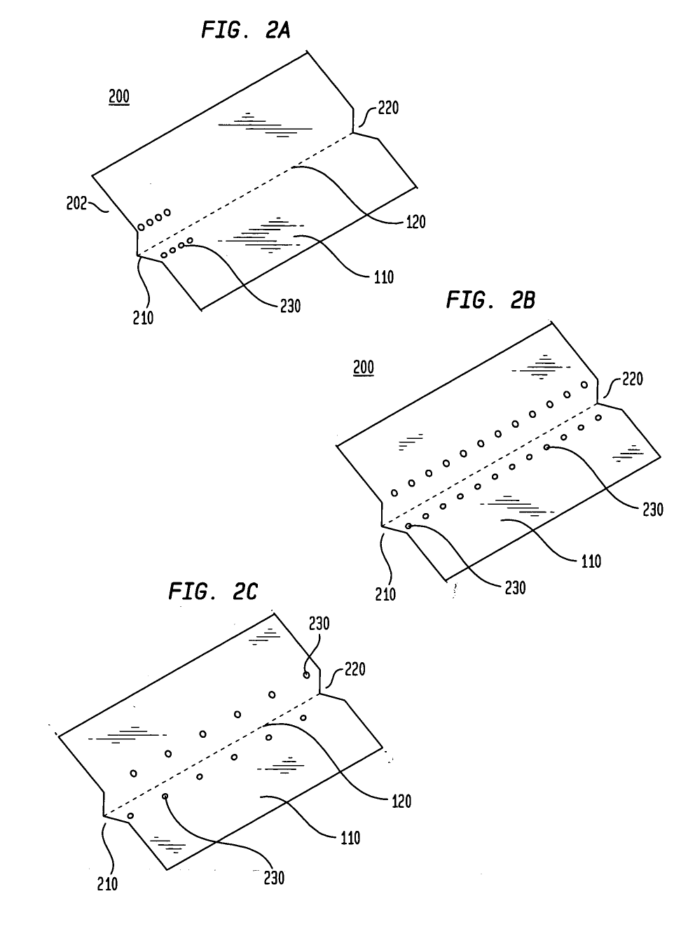

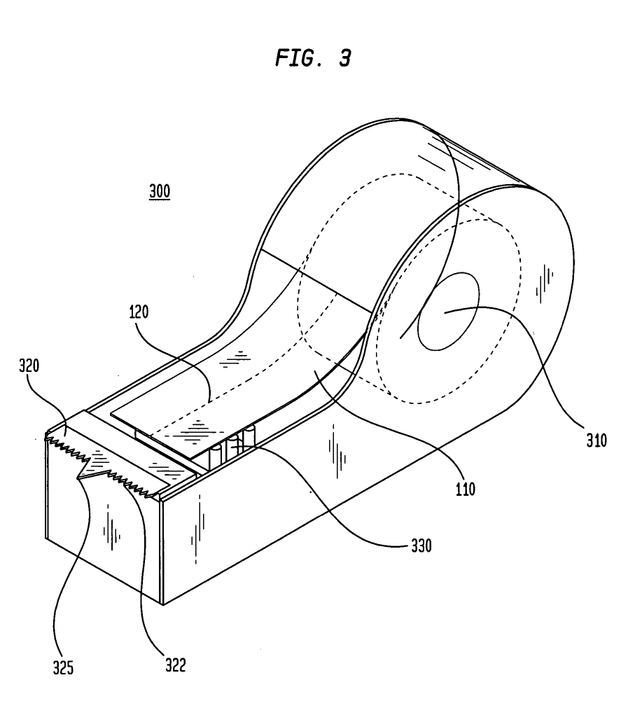

FIG. 2a illustrates a second embodiment 200 of the invention. In this embodiment, tape 110 includes a tab 210 at a first end 202 that may be used to capture an end of slicing means 120. In still another aspect, also shown in FIG. 2a, tape 110 includes notch 220 that may be used to capture an end of slicing means 120 to begin slicing through tape 110. Although both tab 210 and notch 220 are shown in FIG. 2a, it would be recognized by those skilled in the art that either tab 210 or notch 220 may be formed in tape 110 to capture slicing means 120.

Further illustrated are perforations 230 that, in this illustrated case, extend a fixed distance from first edge 202 and tab 210. The use of perforations 230 in tape 110 is advantageous as it insures that the force applied by the slicing means 120, when pulled, will cause tape 110 to tear along perforations 230 and assist in preventing slicing means 120 from being pulled from the tape 110. In the illustrated embodiment, perforations 230 are shown to be within fixed distance, preferably one inch, from tab 210. This aspect of the invention is useful when the material of the sealing tape will tend to tear continuously along an initial cut point, e.g., cellophane. Although not shown, it would be appreciated that perforations 230 may be formed within a fixed distance from notch 220.

FIG. 2b illustrates another aspect of the embodiment shown in FIG. 2a, wherein perforations 230 are placed along an entire length of tape 110. Preferably, perforations 230 are placed substantially adjacent to slicing means 120. Although FIG. 2b illustrates perforations 230 adjacent on both sides to slicing means 120, one skilled in the art would recognize that perforations 230 need only be placed on one side of slicing means 120. Perforations 230 extending substantially the entire length of tape 110 is useful when the material of the sealing tape does not tend to continue tearing along a cut point.

FIG. 2c illustrates another aspect of the embodiment shown in FIG. 2b. In this aspect of the invention, perforations 230 are alternately spaced on both sides of slicing means 120.

FIG. 3 illustrates an exemplary embodiment 300 of a device suitable for creating dispensing sealing tape 110. In this illustrated embodiment, tape 110 including integrated slicing means 120 is contained on roll 310 and stretched toward cutting edge 320. Cutting blade 320 having a cutting edge 322 including notching means 325 that extends past edge 322. Notching means 325 allows for the creation of notch 220 (see FIG. 2a) in a cut or second edge of tape 110, when tape 110 is passed over and cut by cutting edge 322. As would be recognized by those skilled in the art, when notch 220 is created in a cut edge of tape 110 tab 210 (FIG. 2a) is concurrently also created in a first edge 202 of the remaining tape 110.

Further illustrated is perforation means 330 that is positioned to create perforations 230 substantially adjacent to the center line of tape 110. Perforation means 330 may be used to selectively pierce tape 110 to create perforations 230 adjacent to slicing means 120. In another aspect, a second perforation means 330′ may be positioned substantially adjacent to a second side of slicing means 120 to create perforations 230 adjacent to slicing means 120 opposite perforations 230 created by first perforation means 330.

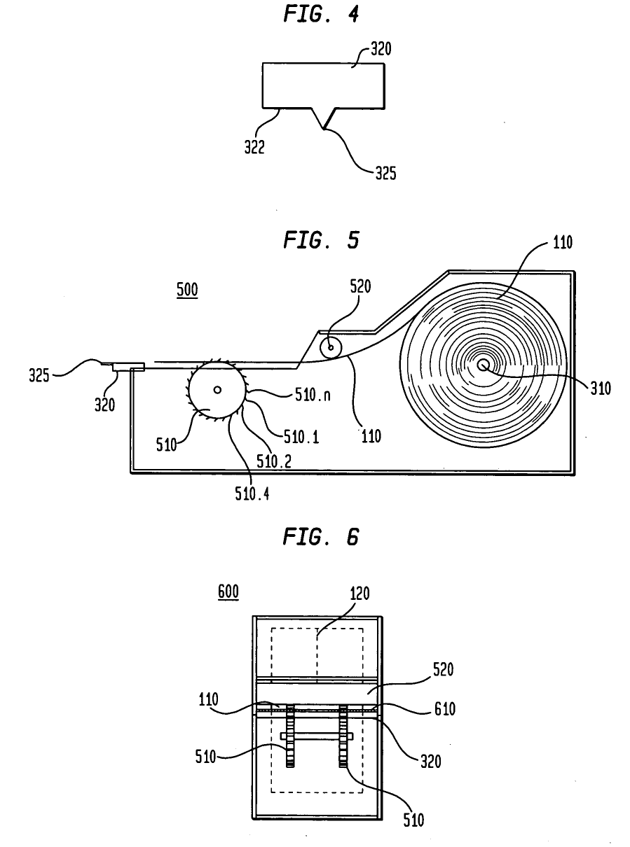

FIG. 4 illustrates a top view 400 of an exemplary cutting edge in accordance with one aspect of the invention. In this illustrated view, notching means 325 is shown substantially centered in cutting blade 320 and extending past edge 322. In this case, edge 322 is a straight edge, which was previously depicted serrated in FIG. 3.

FIG. 5 illustrates a side view 500 of an exemplary embodiment of an apparatus for creating and dispensing a sealing tape in accordance with the principles of the invention. In this illustrated view, tape 110 is positioned on roller 310 and extends toward cutting blade 320. In this case, protrusion means 330 is shown as a circular means, e.g., wheel or roller 510, containing a plurality of external spokes 510.1-510n that may be used to create perforations 230 along one side of slicing means 120 within a fixed length from cutting blade 320 or along the entire length of tape 110 as it is unrolled from roller 310. Also shown is fixed wheel or roller 520 that may be used to apply a pressure to tape 110 as it is extracted from roller 310.

FIG. 6 illustrates a top view of the apparatus shown in FIG. 5. In this illustrated view, protrusion means 330 is situated such that slicing means 120 is substantially centered with respect to protrusion means 330. In this illustrated aspect of the invention, protrusion means 330 is represented as two wheels, each containing external spokes. In another aspect, protrusion means 330 may be a roller containing one or two sets of external spokes. Although not shown, it would be recognized that only a single set of external spokes may be used, in which case only a single set of protrusions 230 is created in tape 110.

Also shown is tape guide 610 that may be used to guide and retain tape in a fixed position relative to protrusion means 330 or 510 and cutting blade 320.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

1. A package sealing tape comprising:
a material having a first and second edge substantially perpendicular to a longitudinal axis, said material having an adhesive composition on a first side; and
a slicing means substantially centered in said material substantially parallel to said longitudinal axis.

2. The tape as recited in claim 1, further comprising:
a tab on said first edge substantially centered in said material with regard to said longitudinal axis.

3. The tape as recited in claim 1, further comprising:
a notch on said second edge substantially centered in said material with regard to said longitudinal axis.

4. The tape as recited in claim 1, wherein said material is selected from the group consisting of: cellophane, paper.

5. The tape as recited in claim 1, further comprising:
a plurality of perforations positioned substantially parallel to said slicing means beginning substantially at and extending a fixed distance from said first edge.

6. The tape as recited in claim 1, further comprising:
a plurality of perforations positioned substantially parallel to said slicing means beginning substantially at and extending a fixed distance from said second edge.

7. The tape as recited in claim 5, wherein said fixed distance extends from substantially said first edge to substantially said second edge.

8. The tape as recited in claim 1, wherein said adhesive composition is selected from the group consisting of: dry adhesive, wet adhesive.

9. The tape as recited in claim 1, wherein said slicing means is selected from the group consisting of: cord, string, wire.

10. The tape as recited in claim 9, wherein a material for said slicing means is selected from the group consisting of: rope, hemp, nylon, metal.

11. The tape as recited in claim 6, wherein said plurality of perforations are placed adjacent to a first side of said slicing means.

12. The tape as recited in claim 11, wherein said plurality of perforations are placed adjacent to a second side of said slicing means.

13. The tape as recited in claim 12, wherein said plurality of perforations alternate between said first and second side.

14. An apparatus for dispensing packing tape along a longitudinal axis of said packing tape comprising:
a cutting blade operable to cut said packing tape substantially perpendicular to said longitudinal axis;
a roller operable to deliver said packing tape to said cutting blade;
at least one protrusion creating means positioned between said cutting blade and said roller operable to create a plurality of protrusions a fixed distance from an edge created by said cutting blade.

15. The apparatus as recited in claim 14, wherein said cutting blade includes notching means operable to create a notch substantially in a center of said edge created by said cutting blade.

16. The apparatus as recited in claim 15, wherein said protrusion creating means comprises:
a plurality of spokes operable to pierce said tape substantially parallel and adjacent to a center line of said packing tape.

17. The apparatus as recited in claim 16, wherein said protrusions are positioned substantially adjacent to both sides of said center line.

18. The apparatus as recited in claim 17, wherein said protrusions are alternately positioned adjacent to both sides of said center line.

19. The apparatus as recited in claim 14, wherein said fixed distance is at least one inch.

20. The apparatus as recited in claim 16, wherein said protrusion creating means comprises:
at least one wheel having a plurality of externally positioned spokes thereon.

21. The apparatus as recited in claim 16, wherein said protrusion creating means comprises:
a roller having at least one set of external spokes thereon.

22. The apparatus as recited in claim 14, wherein said cutting edge is selected from the group consisting of: serrated, straight.
